(19) United States
(12) Patent Application Publication
(10) Pub. No.: US 2026/0260957 A1
(43) Pub. Date: Sep. 3, 2026

(54) METHODS OF RECOVERING ELECTRODE ACTIVE MATERIALS FROM LITHIUM-ION BATTERIES AND ELECTRODES THEREOF

(71) Applicant: The Trustees of Indiana University, Bloomington, IN (US)

(72) Inventors: Hosop Shin, Carmel, IN (US); Md Sajibul Alam Bhuyan, Urbana, IL (US)

(21) Appl. No.: 19/155,780

(22) PCT Filed: Feb. 20, 2024
(86) PCT No.: PCT/US2024/016507

§ 371 Date: Aug. 12, 2025

Related U.S. Application Data
(60) Provisional application No. 63/485,691, filed on Feb. 17, 2023.
(60) Provisional application No. 63/487,418, filed on Feb. 28, 2023.

(51) Int. Cl. H01M 10/54; B32B 43/00; C01G 53/504; C08J 11/08

(52) U.S. Cl. CPC H01M 10/54; B32B 43/006; C01G 53/504; C08J 11/08; B32B 2457/10; C01P 2002/50; C01P 2002/72; C01P 2002/85; C01P 2002/88; C01P 2004/03; C01P 2006/40; C08J 2327/16

(57) ABSTRACT

Methods of recycling and recovering lithium-ion batteries (LIB) and electrode materials thereof, including recovering reusable electrode materials from spent LIBs and electrode scraps produced as a byproduct of LIB production. An electrode sheet is separated from a lithium-ion battery or obtained as a component of a lithium-ion battery. The electrode sheet includes an electrode active material, a polyvinylidene fluoride binder, a carbon-based material, and a current collector. At least a portion of the electrode sheet is immersed in propylene carbonate to delaminate the electrode active material from the current collector and form a solid/liquid mixture. The propylene carbonate is separated from the solid/liquid mixture and the electrode active material is separated from the polyvinylidene fluoride binder, the carbon-based material, and the current collector.

### STATEMENT REGARDING FEDERALLY SPONSORED RESEARCH OR DEVELOPMENT

This invention was made with government support under Grant/Contract Number 2138553 awarded by the National Science Foundation. The Government has certain rights in the invention.

### BACKGROUND OF THE INVENTION

The invention generally relates to methods of recycling and recovering (reclaiming) lithium-ion batteries (LIB) and electrode materials thereof. The invention particularly relates to methods of recovering reusable electrode materials from spent LIBs and electrode scraps produced as a byproduct of LIB production.

LIBs are widely used in many applications, including portable devices, consumer electronics, hybrid and electric vehicles (EVs), and stationary energy storage systems. Due to the anticipated massive growth of the EV market, a large number of LIBs will be required and manufactured to support this growth. Some estimates place the demand for LIBs reaching 2,000 GWh per year in 2030, requiring the disposal or recycling of over five million metric tons of LIBs. This rapid growth leads to not only concerns regarding the uncertainty of the supply chain of raw materials, including lithium (Li), cobalt (Co), and nickel (Ni), used in manufacturing new LIBs, but also concerns regarding the management of hazardous, albeit valuable, wastes generated from the disposal of spent LIBs.

Such forecasts require environmentally-friendly and cost-efficient methods of recycling and/or disposal of both LIBs at their end-of-life (EOL) and electrode (anode and cathode) scraps produced as a byproduct of manufacturing. Reusing spent batteries and electrode scraps and/or recovering electrode materials from them provides environmental benefits when compared to appropriate disposal methods and addresses supply-chain and resource limitation concerns endemic to the LIB and EV industry. In addition to the aforementioned advantages LIB and electrode scrap recycling provides, it may also provide economic advantages if cost-effective recycling processes are developed. However, due to technical and economic issues, less than 5% of LIBs are currently recycled. If a profitable, environmentally sustainable LIB recycling technology were to be provided, EOL LIBs and electrode scraps would become a viable secondary source for LIB manufacturing raw materials while simultaneously addressing environmental concerns. Therefore, developing such recycling processes is critical to securing a circular LIB battery economy and improving the sustainability of the EV industry.

Current LIB and electrode scrap recycling technologies include pyrometallurgical and hydrometallurgical processes. Pyrometallurgy involves a smelting process which is energy-intensive and therefore economically inefficient. Hydrometallurgy involves the use of acids to leach valuable electrode materials into solutions, which is both environmentally unfriendly and presents scaling challenges due to the substantial use of toxic and expensive acids and solvents. In both cases, electrode materials are converted into lower-value metal constituent materials rather than being reused and recycled for direct use in manufacturing new LIBs, a process known as “direct recycling.”

Direct recycling, a recent introduction to the EV LIB industry, aims to recover and repair electrode active materials, such as transition metal oxides for cathodes and graphite and silicon for anodes, in forms directly reusable in manufacturing new LIBs. In order to be useable in direct recycling technology, electrode active materials must be separated from EOL LIB and electrode scrap and furthermore separated from other unusable electrode components, including organic binders (e.g., polyvinylidene fluoride (PVDF)) and carbon-based additives (e.g., carbon black), without damaging the electrode active materials. In order to be directly recycled, active electrode materials must exhibit high purity and maintain their original morphological, structural, and electrochemical characteristics.

Dipolar aprotic organic solvents, such as N-methyl pyrrolidone (NMP) and N, N-dimethylformamide (DMF), are commonly used in solvent-based separation methods to dissolve the PVDF binder and recover cathode materials. NMP effectively disrupts the strong interchain bonds in the PVDF crystal structure and weakens the polymer's attachment to the Al foil without causing any molecular or microstructure changes. However, NMP and DMF are classified as restricted organic substances under the Registration, Evaluation, and Authorization of Chemicals (REACH) due to their adverse effects on human health and the environment. Therefore, there is a strong desire to minimize their large-scale usage. More recently, alternative solvents that are safer and more environment-friendly have been proposed for sustainable cathode liberation (delamination) from the remaining components of the electrode, including the current collector. These solvents have included ethylene glycol (EG), triethyl phosphate (TEP), and Cyrene. While EG can achieve complete cathode delamination at high temperatures, it may make the separation of PVDF from the cathode active material challenging. On the other hand, Cyrene, although effective, is relatively expensive compared to the other solvents, which reduces its cost-effectiveness for cathode separation. TEP, despite having flash and boiling points similar to EG, may not be a sustainable option for cathode recycling over time due to its extensive use in various industrial sectors, contributing to the depletion of phosphorus from the earth's crust.

Therefore, there is an ongoing need for methods capable of separating electrode active materials from EOL LIBs and electrode scraps while maintaining both high purity and their original particle morphology, crystal structure, and electrochemical performance, thereby enabling direct recycling and accelerating advances in direct recycling technology.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, methods of recycling and recovering lithium-ion batteries (LIB) and electrode materials thereof, including recovering reusable electrode materials from spent LIBs and electrode scraps produced as a byproduct of LIB production.

According to a nonlimiting aspect of the invention, a method includes providing an electrode sheet by separating the electrode sheet from a lithium-ion battery or obtaining the electrode sheet as a component of a lithium-ion battery. The electrode sheet comprises an electrode active material, a binder, and a current collector. The method further includes immersing at least a portion of the electrode sheet in propylene carbonate and, while at least the portion of the electrode sheet is immersed in the propylene carbonate, delaminating the electrode active material from the current collector and forming a solid/liquid mixture comprising the electrode active material suspended in the propylene carbonate and the binder dissolved in the propylene carbonate. The propylene carbonate is separated from the solid/liquid mixture and the electrode active material is separated from the binder and the current collector.

Technical aspects of methods as described above preferably include the ability to recover electrode active materials from EOL LIBs and electrode scraps produced as a byproduct of new LIB manufacturing. Preferred aspects of such methods include the capability of providing an efficient, cost-effective, and environmentally sustainable separation process that enables direct recycling methods and accelerates direct recycling technology.

Other aspects and advantages will be appreciated from the following detailed description.

### BRIEF DESCRIPTION OF THE DRAWINGS

FIG. 1 is a flowchart diagram representing a method of liberating and separating cathode active materials from a PVDF binder using propylene carbonate (PC) as a solvent (sometimes referred to herein as a “PC-based liberation/separation process” or more simply “PC-based process”) according to a nonlimiting aspect of the present invention.

FIGS. 2A, 2B, and 2C are graphs representing comparisons relating to the delamination efficiency of an LiNi_{0.5}Mn_{0.3}Co_{0.2}O₂ (NMC532) cathode active material from an aluminum (Al) current collector (foil) of an electrode (cathode) sheet using a PC-based liberation/separation process such as presented in FIG. 1. FIG. 2A compares the delamination efficiency of the cathode active material using the PC-based liberation/separation process in which the PC-based process was performed on different samples of the cathode active material with the PC at different temperatures. FIG. 2B compares the delamination efficiency of the cathode active material using different solvents, one of which being the PC-based liberation/separation process. FIG. 2C compares the delamination efficiency of the cathode active material from different types of electrodes using the PC-based liberation/separation process. Unless noted otherwise, all experiments were performed with an industrial-grade NMC532 electrode that had not previously been installed in an LIB. The efficiency of cathode delamination was estimated by measuring the weight of the Al foil after the liberation process. The mass of the entire cathode coating (consisting essentially of the cathode active material, PVDF binder, and carbon black as a carbon-based additive material) liberated from the Al foil was compared before and after the delamination process. The recovery of the cathode active material from the delaminated cathode coating was approximately 70% for the PC-based liberation/separation process.

FIGS. 3A, 3B, and 3C schematically represent mechanisms believed to underly a PC-based liberation/separation process such as presented in FIG. 1. FIG. 3A represents PVDF dissolution via polymer chain disentanglement at an elevated temperature. FIG. 3B represents PVDF dissolution by enhancement of the solvent-polymer interaction via cross-linking of hydrogen bonds. FIG. 3C represents cathode coating delamination via cross-linking of hydrogen bonds between the hydrogen (H) atoms in a PC solvent and the oxygen (O) atoms in a thin aluminum oxide layer on an Al foil.

FIG. 4A is an SEM image of an Al foil recovered after a PC-based liberation/separation process such as presented in FIG. 1, and FIG. 4B is the corresponding EDX spectra of the recovered Al foil.

FIGS. 5A, 5B, 5D, and 5E contain SEM images depicting the morphology of NMC532 cathode active materials before (FIGS. 5A and 5B) and after (FIGS. 5D and 5E) liberation and separation from an Al foil using a PC-based liberation/separation process such as presented in FIG. 1, and FIGS. 5C and 5F are graphs depicting the EDX spectra of the NMC532 cathode active materials before (FIG. 5C) and after (FIG. 5F) the PC-based liberation/separation process.

FIGS. 6A through 6C contain graphs comparing pristine samples of an NMC532 cathode active material to an NMC532 cathode active material that was recovered from an Al foil using a PC-based liberation/separation process such as presented in FIG. 1. FIG. 6A plots XRD patterns of the pristine and recovered NMC532 cathode active materials. FIG. 6B plots a TGA comparison of the pristine and recovered NMC532 cathode active materials as well as an NMC532 cathode active material manually scraped from an Al foil. FIG. 6C plots a TGA comparison of an NMC532 cathode active powder material, a mixture of powders of an NMC532 cathode active material, PVDF, and carbon black (94:3:3 wt. %), and a mixture of powders of an NMC532 cathode active material and carbon black (94:6 wt. %).

FIGS. 7A through 7D are graphs representing electrochemical performances of a cathode containing an NMC532 cathode active material recovered by a PC-based liberation/separation process such as presented in FIG. 1, in comparison to an NMC532 cathode active material of a baseline cathode. FIG. 7A plots charge-discharge profiles at the end of the formation cycle (5th cycle, C/10 rate). FIGS. 7B and 7C are Nyquist plots after the 5th cycle and 100th cycle. FIG. 7D compares the cycle performance at C/3 rate.

FIGS. 8A and 8B contain conceptual illustrations of a surface modification derived from a PC-based liberation/separation process such as presented in FIG. 1. FIG. 8A represents the dissociation of solvated Li ions via PC molecules incorporated in the PVDF residue. FIG. 8B represents Li-ion movement through the polymer structure of the PVDF residue.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including embodiment(s) depicted in the drawings. The following detailed description also describes certain investigations relating to the embodiment(s), and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter that at least provisionally is regarded to be aspects of the invention, including certain but not necessarily all of the aspects and alternatives described in the detailed description.

Described below are methods capable of direct recycling of cathode active materials from LIB electrodes and electrode scraps utilizing propylene carbonate (PC) in what is referred to herein as a PC-based liberation/separation process. PC is intended as a safer and more sustainable alternative to toxic solvents such as NMP and DMF when used to liberate and separate a cathode active material from a current collector, for example, an aluminum (Al) foil, in an LIB recycling process. PC is a polar, aprotic solvent with low toxicity and possesses a higher boiling point and lower vapor pressure compared to other green solvents. These physical properties of PC are advantageous in reducing the risk of adverse health effects, minimizing solvent loss or emission, and enhancing safe handling and operation for battery recycling applications. PC is a CO₂-based “carbon-sequestering” solvent that can be degraded by certain microorganisms. Recycling PC is feasible as it can degrade and return to the natural carbon cycle more rapidly compared to non-biodegradable solvents. As such, PC has the potential for being biodegradable and economically viable in large-scale applications. The use of PC in LIB recycling processes further has the potential to reduce pollution and minimize the environmental footprint associated with using a solvent in a solvent-based separation method to dissolve a PVDF binder and recover various cathode active materials.

Although the solubility parameters of PC, such as the Hansen and Hildebrand parameters, suggest a relatively lower solubility of PVDF compared to other solvents that have been evaluated, experimental investigations described below indicated that PC surprisingly demonstrated a high capacity for PVDF dissolution within a particular range of temperatures. The inability for the Hansen and Hildrebrand parameters to suggest the suitability of PC as a solvent for PVDF is believed to be attributed to polymer solubility in solvents being a complex process influenced by various factors, including chemical, morphological, thermodynamic, and kinetic considerations, which are interconnected.

In the investigations, a PC-based liberation/separation process was developed and used that was able to recover (reclaim) a cathode active material at comparatively lower temperatures than other solvent-based methods. The effectiveness of the PC-based liberation/separation process was assessed by conducting cathode delamination tests with different electrode types and comparing the results with those obtained using other green solvents. The investigations also explored potential mechanisms underlying the dissolution and deactivation mechanisms of PVDF using PC. Cathode active materials recovered using the PC-based liberation/separation process used during the investigations demonstrated preserved functional characteristics, retaining their original morphology, chemical structure, and electrochemical reactivity. Significantly, the recovered cathode active materials exhibited comparable reversible capacity and electrochemical performance to that of the original cathode material.

Though various cathode active materials may benefit from the PC-based liberation/separation process described herein, a cathode active material having a lithium-nickel-manganese-cobalt composition was chosen. In particular, the investigations evaluated LiNi_{0.5}Mn_{0.3}Co_{0.2}O₂ (hereinafter, NMC532) active material commonly used in industrial-grade cathode electrodes. The investigations included evaluation of a new (not previously installed and used in an LIB) NMC532 cathode having an areal loading about 11.4 mg/cm², in which the NMC532 cathode active material constituted about 94.2% of the cathode. To systematically evaluate the efficiency of the PC-based liberation/separation process, a spent NMC532/LiMn₂O₄ cathode electrode extracted from an 80% state of health (SOH) battery cell was also evaluated, as was a lab-made NMC532 cathode electrode. In addition to NMC532, the lab-made cathode contained carbon additives and a PVDF binder in a weight ratio of about 94.3:3. The cathode electrodes were characterized by having their NMC532 cathode active materials strongly bonded to each other and to an aluminum (Al) foil with a PVDF binder. The strong bonds between an NMC532 cathode active material, a PVDF binder, and an Al foil are known to pose a challenge in their effective separation while preserving their functional structures.

In addition to PC (>99.7%), the solvents evaluated during the investigations included, triethyl phosphate (TEP; >98%), ethylene glycol (EG; >99.5%), and n-methyl-2-pyrrolidine (anhydrous, >99%), all of which were used without any treatment.

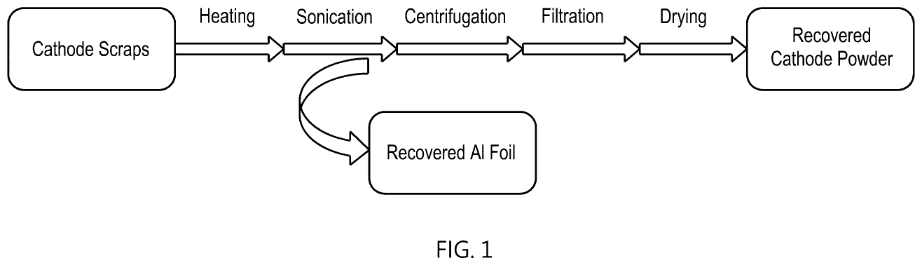

FIG. 1 represents a schematic flowchart of the particular PC-based liberation/separation process that was utilized for the investigation. Cathode scraps were obtained by cutting, and the resulting electrode portions (pieces) were immersed in PC at a prescribed temperature and stirred for about five minutes. The resulting electrode-solution (solid/liquid) mixture was then placed in a sonication bath for about one minute during which a majority of the cathode active material and carbon-based additive material (carbon black) were observed to have been liberated from the Al foil. After the liberation process, the resulting black-colored solution was centrifuged and washed three times to finally separate and remove the carbon additive and PVDF binder from the solution. The remaining NMC532 cathode active material was in powder form and collected, filtered and vacuum-dried overnight at 100° C.

Samples of the NMC532 powder and Al foils recovered as described above were subjected to various characterization techniques to analyze their surface morphologies, phases, crystallinities, and compositions. Scanning electron microscopy (SEM) equipped with energy-dispersive X-ray spectroscopy (EDAX) was used to examine the surface morphologies and compositions of the samples, and X-ray diffraction (XRD) was employed to determine phase and crystallinity of the samples. XRD measurements were conducted over a 2θ angle range of 10 to 70° at a scanning rate of 0.85°/min. Thermogravimetric analysis (TGA) was carried out to investigate the compositions and thermal stability of the samples. TGA measurements were performed at a ramping rate of 5° C./min in an argon (Ar) flow (50 mL/min) over a temperature range of about 25 to about 800° C. The characteristics of the recovered NMC532 samples were compared with those of NMC532 electrodes and powders that did not undergo the PC-based liberation/separation process.

Cells were fabricated with the recovered NMC532 powders to obtain electrochemical measurements. For this purpose, the NMC532 powders (94.2 wt. %) were mixed with carbon additives (2.9 wt. %) and PVDF binder (2.9 wt. %) to form a slurry. The resulting slurry was then coated onto an Al foil using a doctor's blade to yield a coated electrode that was subsequently vacuum-dried overnight at 120° C. To achieve the thickness of an industrial-grade NMC electrode, the dried electrode was calendared. The areal loading of the electrode was approximately 12.0 mg/cm², which closely matched the target loading of 11.4 mg/cm². For electrochemical tests, coin cells were assembled in a half-cell configuration (recovered NMC532 electrode vs. Li counter/reference electrode) in an Ar-filled glovebox. The electrolyte used was a 1.2 M solution of LiPF₆ in a mixture of ethylene carbonate and ethyl methyl carbonate with a volume ratio of about 1:1. The cells were rested for 12 hours and then subjected to five charge/discharge cycles at a C/10 rate using a constant current/voltage (CC−CV) charge and a CC discharge protocol, followed by 100 cycles at a C/3 rate using a CC charge and discharge protocol. The cells were cycled within a potential range of 3.0-4.2 V (Li/Li⁺). Electrochemical impedance spectroscopy (EIS) tests were conducted after 5 and 105 cycles in the fully discharged state (i.e., 3.0 V vs Li/Li⁺) by applying a 5 mV amplitude perturbation over a frequency range of 500 kHz to 0.1 Hz.

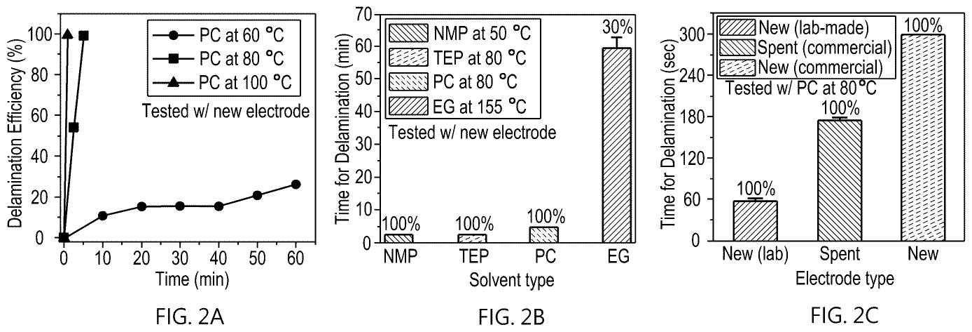

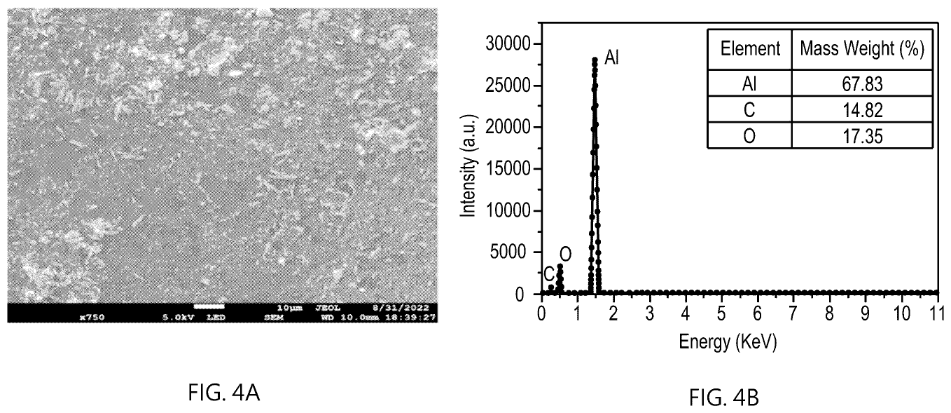

Previous studies have shown that direct cathode liberation/separation using green solvents typically requires high temperatures exceeding 100° C. to induce swelling of the PVDF polymer chains through fast solvent diffusion. However, the use of high temperatures for direct cathode recovery comes with increased energy consumption, which raises concerns regarding safety and processing costs. In the investigations, it was demonstrated that PC can liberate (delaminate) a coating of cathode active materials from a current collector (such as an Al foil) at relatively low temperatures, preferably less than 100° C., for example, about 80° C. FIG. 2A plots cathode liberation efficiency at different temperatures during the liberation phase of the PC-based liberation/separation process. To test the cathode delamination efficiency, the new industrial-grade NMC532 electrode exhibiting strong bonding between the Al foil and NMC532 cathode coating was used. Several pieces of the NMC532 electrode were immersed in PC solvent at target temperatures of 60° C., 80° C., 100° C. The solid/liquid mixture was then stirred at a target temperature for five minutes followed by one minute of sonication. This process was repeated until complete cathode delamination occurred, while calculating the liberation efficiency. The clear mixture solution turned into a black-colored solution with a black mass after five minutes of stirring at 80° C. followed by one minute of sonication. After the liberation process, the cathode coating was completely delaminated from the Al foil, and the NMC cathode active material was not detected on the recovered Al foil (FIGS. 4A and 4B). It was noted that the mechanical force via a short sonication was employed to completely break down the weakened bonding between the cathode coating and the Al foil. A longer sonification time was not effective in further increasing the delamination efficiency. However, when the liberation process was performed at a lower temperature (60° C.), complete cathode delamination was not achieved, exhibiting approximately 26% of the liberation efficiency after a total of one hour of stirring and six minutes of sonication. This suggests that the PC-based liberation efficiency is dependent on the combination of temperature and duration, and sufficient heat is required to activate the PVDF polymer-PC interaction. Based on the result, a preferred temperature for PC-based liberation was concluded to be above 60° C., including but not limited to the 80° C. temperature tested.

As evidenced in FIG. 2B, to evaluate the effectiveness of the liberation step of the PC-based liberation/separation process, identical liberation/separation processes were performed using NMP, TEP, and EG to delaminate the same industrial-grade NMC electrode. NMP is known as an effective solvent to dissolve PVDF at room temperature. As expected, NMP delaminated the cathode coating completely from an Al foil at 50° C. for a short time (approximately three minutes followed by one minute of sonication). TEP was also highly effective in delaminating the cathode coating, requiring approximately three minutes of stirring at 80° C. followed by one minute of sonication for complete delamination. However, EG did not achieve complete cathode delamination even at a high temperature (155° C.) showing approximately 30% of the delamination efficiency after one hour of processing. This result was not consistent with previous reports in which EG was used to liberate a cathode coating within a few minutes. This discrepancy might be due to the strong PVDF-Al foil bonding of the new electrode used in this work. Therefore, the PC-based process was further evaluated using different grades of electrodes.

As shown in FIG. 2C, the time required for complete delamination strongly depended on the electrode grade. The new industrial-grade electrode mainly used in the investigations took a longer time (298 sec) than other types of electrodes for complete delamination. On the other hand, the lab-made electrode only required sixty seconds for complete delamination. This suggested that the electrode manufacturing process greatly affected the interaction bonding between a cathode coating and Al foil via a PVDF binder, resulting in different delamination times. In addition, a spent electrode (industrial-grade) took approximately 178 seconds for complete delamination, showing higher liberation efficiency than the new industrial-grade electrode. This indicated that the adhesion strength between a cathode coating and Al foil is weaker for a spent electrode compared to a new electrode. The difference in the adhesion strength between the samples was attributed to the loss of adhesion strength in cycled electrodes upon repeated cycling. The electrode stress caused by expansion and shrinkage of the cathode active material can weaken the adhesion strength of the cathode coating.

Overall, the liberation step of the PC-based liberation/separation process was effective in treating different types of electrodes within a short period of time. The liberation efficiency was comparable with the TEP- or NMP-based process, but much higher than the EG-based process. More importantly, the PC-based liberation/separation process was effective at relatively low temperatures (100° C. but above 60° C.) to recover the cathode material than other green solvents.

PVDF dissolution and cathode delamination mechanisms were explored. Dipolar aprotic solvents including NMP, DMF, TEP, dimethylsulfoxide (DMSO), trimethyl phosphate (TMP), and dimethylacetamide (DMAc) have been identified as dissolving PVDF polymer at 60° C. PC is also a dipolar, aprotic solvent, which suggests that PC could potentially dissolve PVDF. Nevertheless, PVDF dissolution in PC has not been widely studied, possibly due to the lower solubility power in PC with respect to the Hansen solubility parameters. As previously noted above, dissolution of a polymer is a complex process and is governed by thermodynamic factors (e.g., enthalpy and entropy of mixing) and kinetic effects. Although the Hansen parameters can guide the selection of suitable solvents for PVDF dissolution, they do not guarantee accurate solubility degree of PVDF in solvents, especially at elevated temperatures.

To understand the mechanism behind the PC-based liberation/separation process utilized in the investigations, PVDF solubility tests were conducted using PC at different temperatures. After the PVDF (10 wt. %)-PC mixture solution was continuously stirred at 60° C. for six hours, it remained at its clear solution with some white-colored PVDF sediment at the bottom of the solution. The PVDF was not completely dissolved, but it precipitated in a crystalline form upon cooling. This may indicate insufficient PVDF polymer interchain breakdown and PVDF-PC interaction at 60° C. On the other hand, a shallow-yellow colored solution was observed without any PVDF sediment after stirring the mixture solution at 80° C. for six hours. This indicated that decomposition and solubilization of PVDF occurred at 80° C., which was attributed to the reduction of the polymer interchain interaction via penetration of PC into the PVDF crystalline structure.

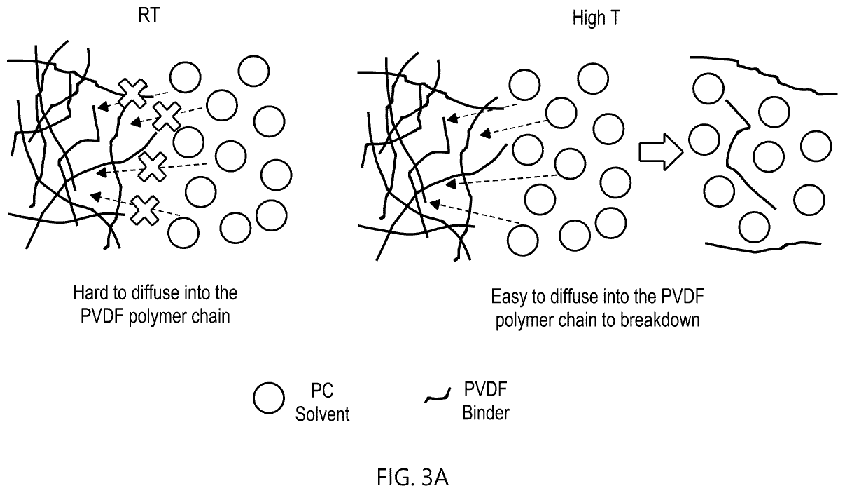

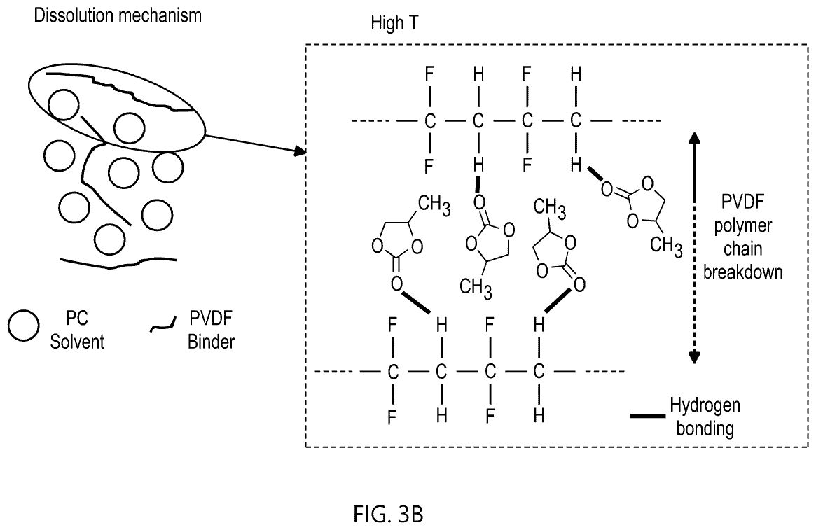

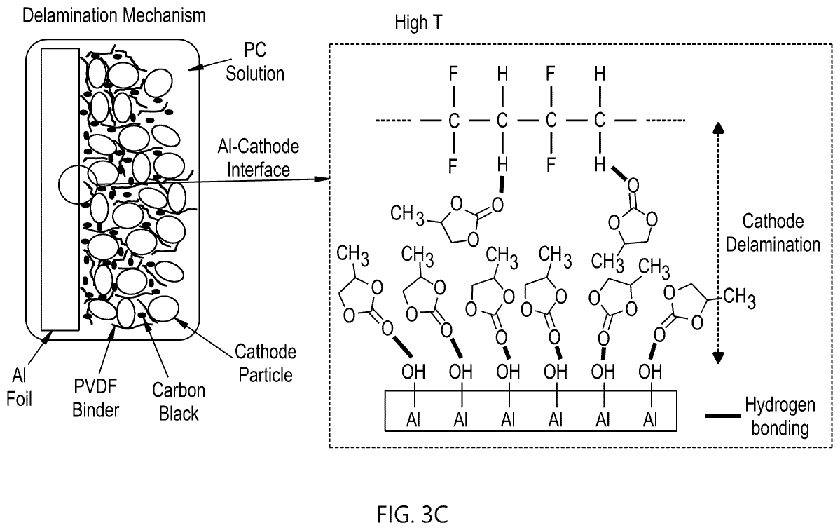

The mechanism of PVDF dissolution at elevated temperatures may be explained by PVDF polymer chain disentanglement (FIG. 3A) and disruption of the PVDF polymer interchain links due to cross-linking of hydrogen bonds (FIG. 3B). As illustrated by the schematic of FIG. 3A, at room temperature the entanglement of the PVDF polymer chains impedes PC diffusion to the crystalline polymer structure. At an elevated temperature, as an example, 60° C. and less, the PVDF polymer structure may be swollen by enhanced PC diffusion, expanding its volume without noticeable dissolution. However, with a sufficiently high temperature (“High T”), for example, 80° C. utilized in the investigation, the penetration of the PC solvent into the PVDF polymer chains may be sufficiently facilitated to considerably accelerate the swelling of the polymer structure. Eventually, the PVDF polymer interchain is deactivated and decomposed, losing its original structure, which was evidenced by the color change of the PVDF-PC solution in the investigation.

Heating the PVDF polymer in PC not only causes the polymer chain disentanglement but is also believed to enhance the PC-PVDF interaction. Once the diffused PC solvent molecules had expanded the PVDF polymer structure and created more sites for the solvent-polymer interaction, there is a higher possibility of establishing cross-linking of hydrogen bonds between the hydrogen (H) and fluorine (F) atoms in PVDF and the H atoms and carbonyl groups in PC (FIG. 3B).

The dissolution and decomposition of the PVDF binder weaken the adhesion strength between the cathode coating and the Al foil. The deactivation of PVDF eventually leads to the liberation of the active material and carbon black from the electrode and the separation of particles of the active material from each other. In addition, cathode delamination may originate from cross-linking of hydrogen bonds between the H atoms in PC and the O atoms in a thin aluminum oxide layer on the Al foil (FIG. 3C). This hypothesis was supported by characterizing the Al foil after the PC-based liberation/separation process. As shown in FIGS. 4A and 4B, after the PC-based process, the recovered Al foil showed no active material particles on its surface, confirming successful cathode delamination from the Al foil. Consequently, no nickel, manganese, or cobalt was observed from the EDX spectra. Moreover, no fluorine was detected from the Al foil surface, confirming the absence of the original PVDF on the surface. Interestingly, a small amount of C and O was identified on the foil surface. These elements, originating from polymerized or adsorbed PC molecules, appear to have strongly adhered to the Al foil surface. This observation may support the mechanism of cathode delamination through the cross-linking of H bonds, a mechanism that appeared to be in agreement with the mechanism of EG-based delamination.

The PC-recovered cathode material was also characterized. Based on the mechanisms described above relating to the Al foil surface, the PC-based liberation/separation process enabled liberating and separating of the cathode active material from the current collector (Al foil). To obtain the active material from the liberated solid mixture, the PC-based process included centrifuge, filtration, and drying (FIG. 1). The collected active material was characterized in terms of morphology, chemical composition, phase, crystallinity, and purity.

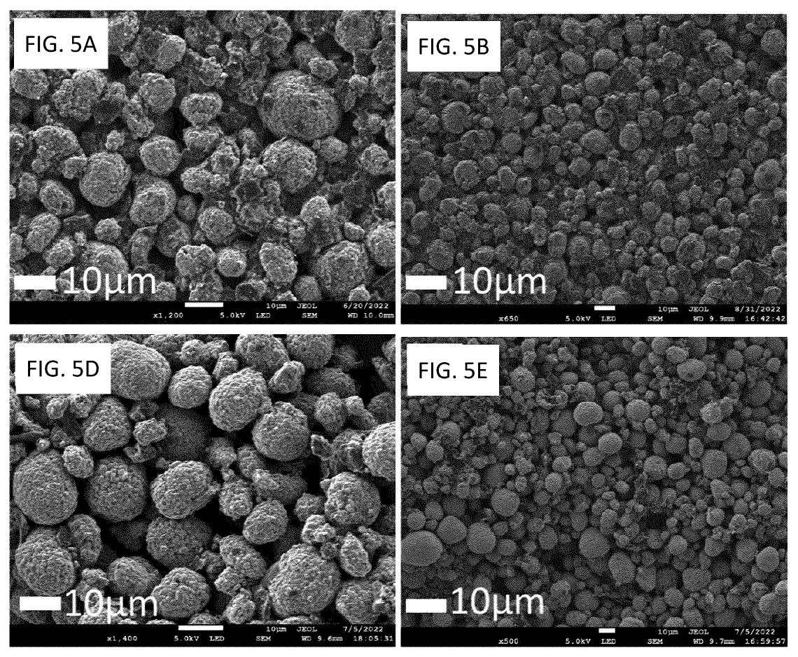

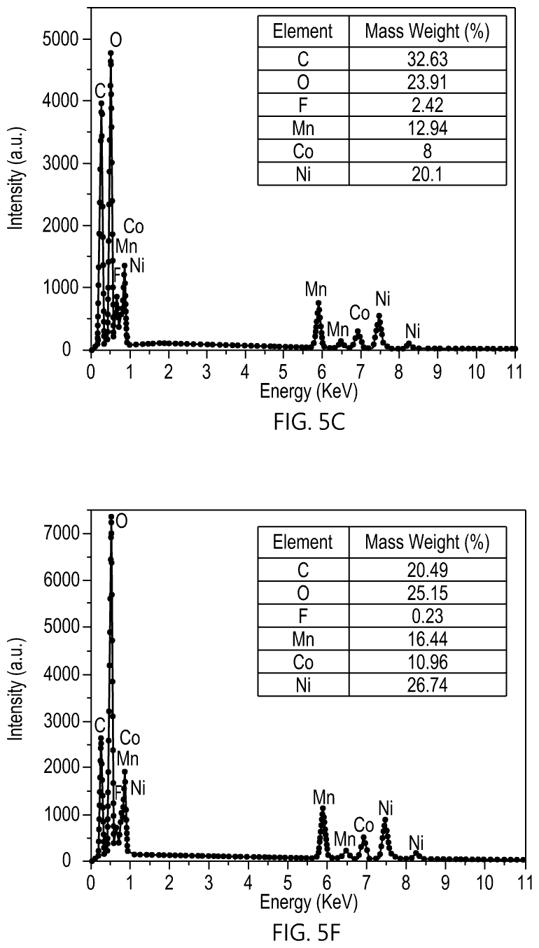

For direct cathode recycling, it is critical to ensure that the original morphology and chemical composition of the active material has been maintained during its recovery. FIGS. 5A-5F depict comparisons of SEM images and EDX spectra of the NMC532 cathode active material before and after the PC-based process. The SEM analysis revealed that the morphology of the recovered NMC particles was retained following the PC-based process. The EDX analysis demonstrated that no transition metal leaching occurred during the PC-based process. Moreover, the recovered NMC532 cathode active material well-preserved the original ratio of Ni, Mn, and Co (5:3:2) after liberation and separation performed by the PC-based process. These observations evidenced that the PC-based liberation/separation process is nondestructive and did not alter the morphology and chemical composition of the active materials, thereby evidencing that the PC-based process is suitable for direct cathode recycling.

However, like other solvent-based processes, it was still challenging to collect 100% of pure NMC active material in the absence of other impurities. FIG. 5F indicates small amounts of residues, including carbon black, PVDF, and polymerized or adsorbed PC substances, remained adhered to the recovered NMC particles, even though significant amounts of carbon black and PVDF were removed during the PC-based liberation/separation process. As shown in FIG. 5F, carbon and fluorine substantially decreased after the PC-based process, but these elements remained in the recovered NMC powder. It should be noted that the carbon and fluorine observed in the recovered NMC cathode powder were attributed to not only carbon black and PVDF residues but also a gel-like polymer substance resulting from a plasticizer effect of PC. PC has been reported to serve as not only a solvent but also a plasticizer for polymers. The gel-like polymer substance that was observed to adhere to the NMC particles mainly consisted of carbon and oxygen, not carbon and fluorine constituting PVDF. This suggested that this gel-like polymer substance was associated with the residual PC molecules adsorbed on or polymerized with PVDF polymer chains. This conclusion was supported by the increase in the amount of oxygen in the recovered NMC cathode active material (FIG. 5F), as well as the observation of carbon and oxygen on the Al foil (FIGS. 4A and 4B). Interestingly, the plasticizer effect of PC was concluded to have a positive influence on electrochemical performance of the recovered cathode. The positive impact of the residual gel-like polymer substance on PC is discussed in further detail below.

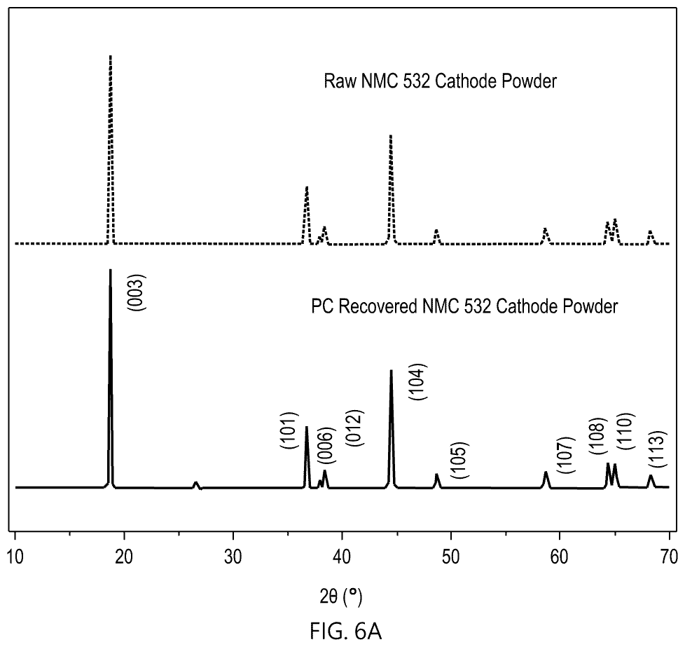

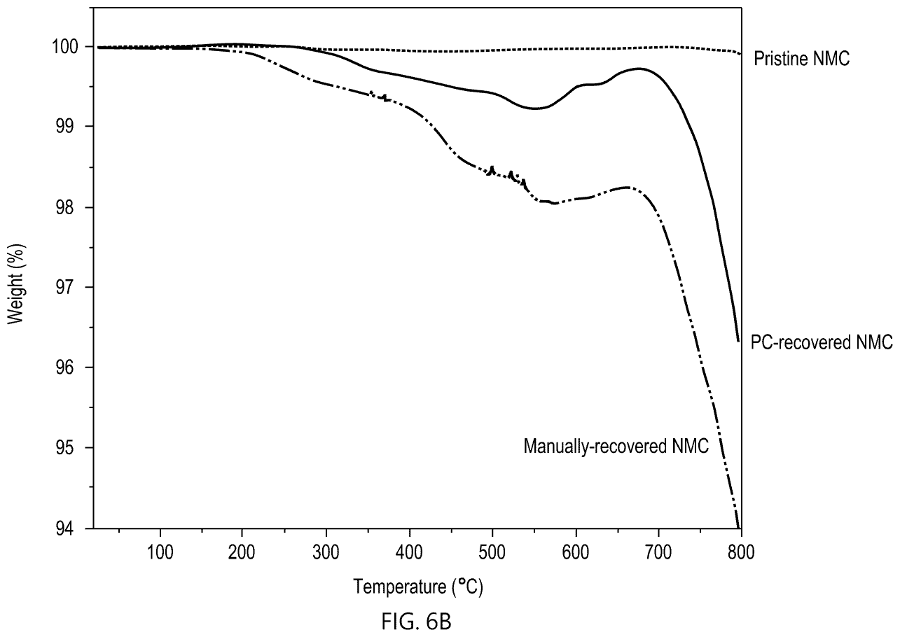

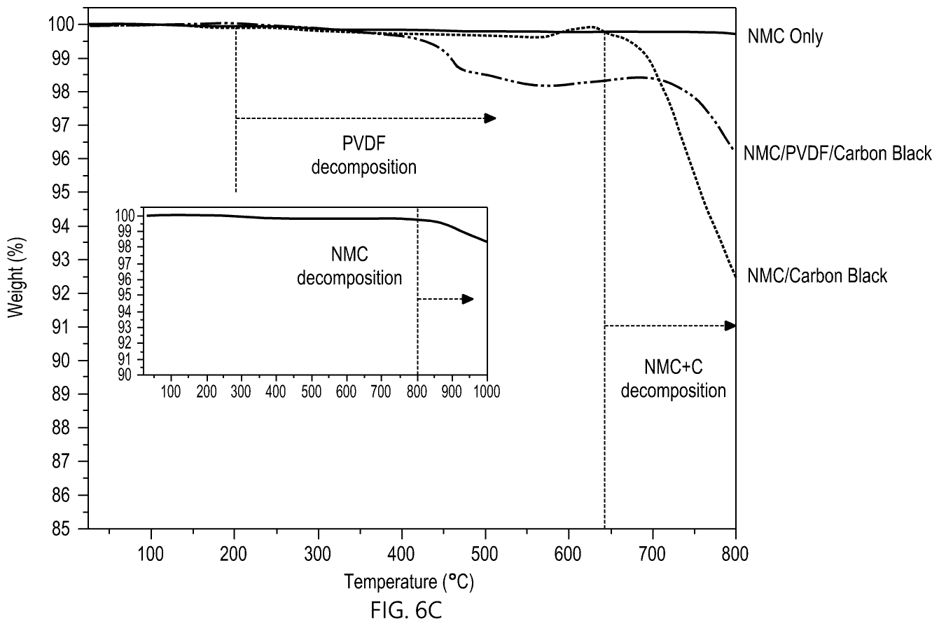

To explore the crystal structure of the PC-recovered cathode, XRD patterns of raw NMC532 and the recovered NMC532 powders were compared. In FIG. 6A, all XRD diffraction peaks were indexed to the R3m space group with the α-NaFeO₂ layered rhombohedral structure, indicating that the crystal structure of the recovered NMC cathode active material was well preserved during the PC-based liberation/separation process. The diffraction peaks of the raw and recovered NMC532 powders were almost identical and no peak shifting or broadening was observed after the PC-based process, which suggested the crystal structure of the recovered NMC cathode active material was well-preserved during the PC-based process. The intensity ratio of (003) and (104) (i.e., the I₀₀₃/I₁₀₄) also did not decrease, confirming that the PC-based process did not deteriorate the crystallinity of the recovered NMC cathode active material. This observation also indicated that no cation mixing and lithium deficiency were observed in the recovered material. However, a small XRD peak at approximately 26.6 degrees was observed and attributed to the presence of carbon residues on the surfaces of the recovered NMC particles.

To further investigate the gel-like polymer substance on the surfaces of the recovered NMC particles, TGA of pristine NMC particles, NMC particles manually recovered (scraped-off) from an electrode, and NMC particles recovered by the PC-based process were compared (FIG. 6B). As expected, no weight loss was observed for the pristine NMC particles up to 800° C. in the absence of carbon black. On the other hand, the manually-recovered NMC particles and the NMC particles recovered by the PC-based process displayed a significant weight loss starting at approximately 650 to about 700° C. The weight losses were attributed to a decomposition reaction of NMC with carbon according to Eq. (1).

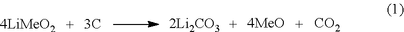

where Me represents transition metals including nickel, manganese, and cobalt. The decomposition reaction leads to the formation of Li₂CO₃ and MeO and the release of CO₂. Upon the reaction of NMC with carbon at elevated temperatures, the following reactions can take place:

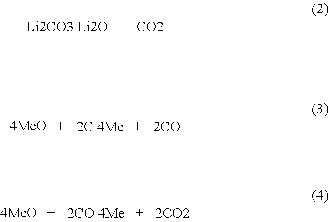

The decomposition of NMC in the presence of carbon black was confirmed by TGA as shown in FIG. 6C. The mixture of NMC/carbon black displayed a rapid weight loss starting at about 650° C., which was not observed for the pure NMC particles in the absence of carbon, further confirming the role of carbon black in the decomposition process. When a reductant, such as carbon, is present along with a lithium transition-metal oxide, it can lower the decomposition temperature of the oxide.

The onset temperature of NMC decomposition can be influenced by the presence of a PVDF binder and/or amounts of carbon content. The mixture of NMC/carbon (94:6 wt. %) showed a lower decomposition temperature (about 650° C.) than the mixture of NMC/PVDF/carbon (94:3:3 wt. %) (about 700° C.).

The TGA also revealed that both the PC-recovered and manually-recovered NMC particles exhibited two minor stages of weight loss. The first stage, occurring around 180-400° C., was attributed to the decomposition of both PVDF residue and the aforementioned gel-like polymer substance. The second stage, occurring around 400-570° C., corresponded to the decomposition of carbon residue. These weight losses indicated the presence of impurities, including PVDF-related and carbon-related species, on the surfaces of both the PC-recovered and manually-recovered NMC particles. Comparing the weight loss percentages, the PC-recovered particles showed a total weight loss of 0.8%, while the manually-recovered particles exhibited a total weight loss of 2.1% (0.7% of PVDF and 1.4% of carbon). This suggested that the PC-based liberation/separation process effectively reduced the number of impurities on the surfaces of the NMC particles. However, even after the PC-based process, the PC-recovered particles still contained carbon residues that induced a rapid weight loss starting at 700° C. The presence of dispersed carbon among the NMC particles was confirmed with EDAX mapping. Additionally, the PC-recovered particles showed a slight weight increase at 550-675° C., which could be attributed to buoyancy effects and oxidation of the PC-adsorbed species, although the exact cause was not determined.

Electrochemical performance of the PC-recovered cathode material was then evaluated. Complete removal of PVDF and carbon residues from the active material may not be feasible by a solvent-based separation process due to the strong bonding therebetween. These residues may have negative effects on battery performance by obstructing the Li-ion pathway in the composite electrode structure and by accelerating side reactions in the battery. Any excess of residual PVDF and carbon beyond an optimized amount may lead to changes in porosity and tortuosity within the original electrode microstructure, affecting battery performance. Furthermore, the performance and functionality of these residual species can differ from their intended purpose, potentially leading to adverse effects on battery performance. Therefore, recovered cathode materials, which may contain impurities such as PVDF and carbon residue, may exhibit increased resistance and capacity fade compared to their pristine counterparts.

To address this issue, the PC-based liberation/separation process was determined to offer a viable approach. Based on electrochemical analyses on the PC-recovered NMC cathode active material, the PC-based process was determined to be able to convert PVDF residues into a Li-ion conducting polymer layer by incorporating PC molecules into the PVDF polymer chains. This transformation of PVDF residues in Li-ion conducting species may help mitigate the negative impact of PVDF and carbon residues on battery performance.

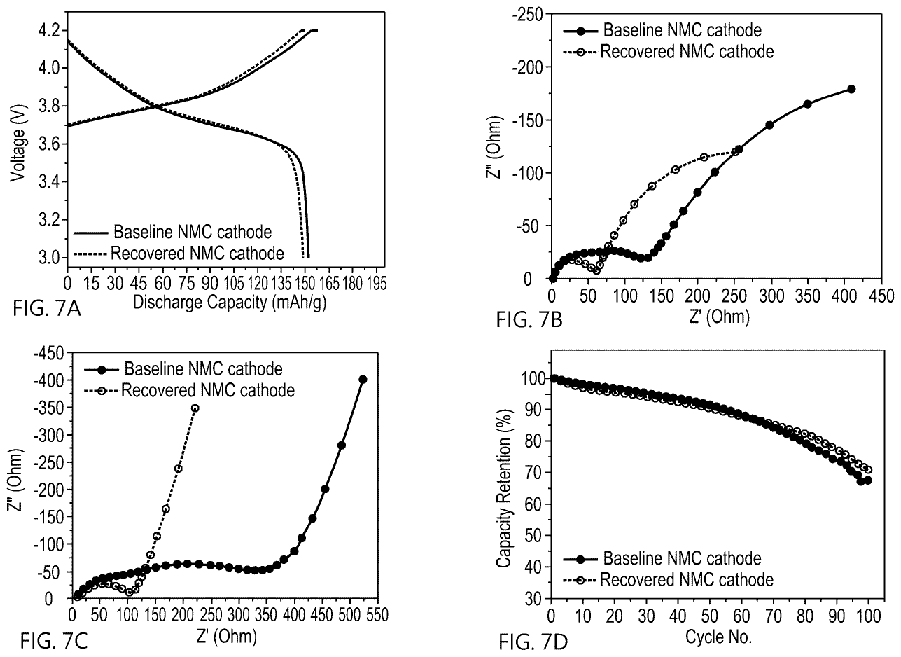

The electrochemical performance of the NMC electrodes before and after the PC-based process is compared in FIGS. 7A through 7D. The charge/discharge profiles (FIG. 7A) of the baseline and PC-recovered cathodes were comparable to each other. Both electrodes showed a well-defined voltage plateau at approximately 3.7 V, at which Li (de) intercalation reactions occur, suggesting that the lattice structure of the recovered cathode remained intact during the PC-based process. The reversible discharge capacity of the recovered electrode was mostly comparable to that of the baseline electrode, with a slight difference attributed to the presence of impurities on the surface of the active material. Considering no significant differences between the baseline and recovered materials in terms of their (003) peak positions and intensity ratios of the (003)/(104) peaks (FIG. 6A), the slight capacity difference was not associated with potential lithium loss of the recovered NMC cathode active material during the PC-based process. ICP analysis also confirmed that there was no significant difference in the lithium ratio between the baseline and recovered materials. These observations confirmed that the PC-recovered electrode retained its original capacity and did not experience a significant deterioration in its electrochemical reactivity. Interestingly, the CV charge capacity of the recovered electrode decreased after the PC-based recovery process, indicating an improvement in cell resistance with the recovered electrode. The reduction in CV charge capacity suggested that the PC-based process effectively addressed the issue of increased resistance caused by PVDF and carbon residues, leading to improved electrochemical performance of the recovered electrode.

The improved cell resistance of the recovered electrode was further confirmed by EIS results. The Nyquist plots in FIGS. 7B and 7C show a clear distinction between the baseline and the recovered NMC cathodes, particularly in the range of the high to medium frequencies, which is indicative of charge-transfer resistance. After the initial five cycles (i.e., formation cycle), the charge-transfer resistance of the recovered electrode decreased compared to the baseline electrode (FIG. 7B). Moreover, the increase in charge-transfer resistance after long-term cycling (i.e., 100 cycles) was significantly lower for the PC-recovered electrode compared to the baseline electrode (FIG. 7C).

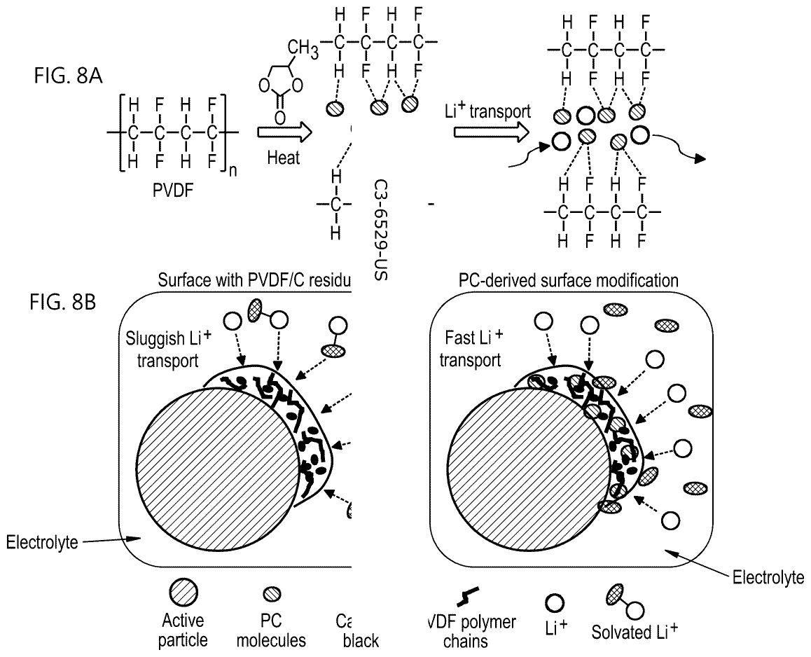

The reduction of charge-transfer resistance observed for the recovered electrode can be associated with the improved ionic conductivity at the electrode/electrolyte interface facilitated by the plasticizer effect of PC. As illustrated in FIGS. 8A and 8B, the surface modification derived by PC during the PC-based liberation/separation process may be one of the possible reasons for the lower charge-transfer resistance of the recovered electrode. During the process, PC molecules are incorporated into the PVDF polymer chains, some of which are trapped in the [—CH2-CF2-]ₙ structure. The incorporated PC molecules not only soften the residual PVDF polymer structure, making it easier for Li ions to move, but also promote the dissociation of solvated Li ions. This PC-incorporated PVDF residue on particles of the cathode active material can act as a Li-ion conducting layer, allowing more efficient Li-ion segmental motion through the C═O and C—F bonds with high electronegativity. This explanation is based upon the Li conduction mechanism of the gel polymer electrolytes incorporating PC, which is widely used as a plasticizer for PVDF-based gel polymer electrolytes. The previous studies have shown that the addition of a PC plasticizer can decrease the glass transition temperatures of the PVDF-based polymers as well as soften the polymer backbones, resulting in high segmental motion for Li ions. The investigation confirmed that PC can interact with PVDF and cause changes in the flexibility of the polymer chains, leading to the formation of the aforementioned gel-like polymer substance product.

Further evidence of PC incorporation into the PVDF polymer can be found in Fourier transform infrared (FTIR) analysis. Significant differences were observed in the FTIR spectra between PC and the gel-like polymer substance (PV-PVDF). Notably, the main band at 1793 cm⁻¹, corresponding to the stretching vibration of C═O in PC, disappeared in the PC-PVDF spectrum. This indicates that the stretching vibration mode of C═O in PC was strongly affected by interactions with other molecules in the PVDF binder. The interactions of PC with the PVDF polymer chains can alter the vibrational properties of the carbonyl group, leading to a loss of the carbonyl peak in the FTIR spectrum. Similarly, the bands at 1184 and 1120 cm⁻¹, assigned to the antisymmetric stretching of C—O—O, were not clearly visible in the PC-PVDF spectrum. Furthermore, the frequency band at 1053 cm⁻¹, corresponding to the symmetric stretching mode of C—O in PC, shifted to a lower wavenumber, 1038 cm⁻¹, for PC-PVDF. These observations provided clear evidence of PC incorporation into PVDF and suggested potential hydrogen bonding interactions between the carbonyl oxygen atoms in PC and the hydrogen atoms in PVDF.

The PC-derived surface modification potentially influenced the cycle performance of the PC-recovered electrode. The capacity retention for the recovered electrode (71.0%) was slightly higher than that of the baseline electrode (67.6%) (FIG. 7C). This slight improvement in cycle performance was attributed to the lower cell resistance associated with faster Li conduction at the electrode/electrolyte interface, facilitated by the PC-derived surface modification. The effectiveness of the PC-derived surface modification can be also observed from the improved rate capability of the recovered electrode compared to the baseline electrode. The enhanced rate capability further validated the positive impact of the surface modification facilitated by the PC plasticizer effect.

Though NMC cathode active materials were investigated, the results of the investigations reported above are believed to be applicable to other electrode active materials, including but are not necessarily limited to transition metal oxides for cathodes and graphite and silicon for anodes. If electrode active materials are to be recovered from an EOL LIB, battery cells of the LIB are preferably fully discharged in order to move available lithium ions back to the cathode of the LIB. The LIB can then be dismantled and its electrode (anode and cathode) sheets collected separately. These steps are not required if the electrode active materials are to be recovered from electrode sheets obtained from electrode scraps.

Based on the above investigation, the PC-based liberation/separation process can generally be summarized as follows. The electrode sheets are preferably shredded or otherwise disassembled into one or more portions, i.e., electrode pieces. For example, the electrode sheets may be mechanically shredded using equipment known to those skilled in the art, or using solvents, or using some combination thereof. If required, residual impurities, such as but not limited to electrolytes, lithium salts, and solid electrolyte interphases (SEIs), are preferably removed from the electrode pieces using solvent washing. Solvents appropriate for such washing include, but are not limited to, PC, dimethyl carbonate, ethylene carbonate, or any other such solvents known to those skilled in the art. The electrode pieces at this stage of the PC-based process generally comprise electrode active materials, binders, carbon-based materials, and current collectors. Thereafter, the washed electrode pieces are immersed in PC to form a solid/liquid mixture. Particularly suitable weight ratios of the electrode pieces to the PC in the mixture are believed to be in a range of about 1:1 to about 1:15, though lower and higher weight ratios are foreseeable. The electrode active materials are then delaminated from the current collectors and separated from other electrode component materials (binders, carbon-based materials, etc.) by stirring the mixture. Based on the investigations, it is believed that the temperature of the mixture during the delamination may be, for example, within a range of about 30° C. to about 200° C., though more preferably above 60° C., and up to 100° C. or more, though more preferably 100° C. or less. The stirring speed may range from about 30 rotations per minute (rpm) to about 3000 rpm. The time required to separate the mixture may vary, depending in part on the temperature of the mixture. The mixture may also undergo sonication for an amount of time to accelerate the delamination and separation process. Stirring and sonication steps may be repeated until all electrode active materials are delaminated from the current collectors and separated from other electrode active materials. In the case of electrode sheets from EOL LIBs, bonding between electrode active materials and current collectors may be relatively weak, and therefore processing time may substantially decreased. In the case of electrode sheets obtained from electrode scraps, bonding between electrode active materials and current collectors is often relatively stronger and processing time may be expected to take longer. Additionally, if large amounts of binder were used in the manufacturing of the electrode sheets, additional processing time may be expected.

Following the delamination and separation process, the PC solvent may be drained from the solid/liquid mixture. At this point, the electrode active materials and other electrode components, including carbon-based materials, are preferably suspended in the mixture with PC. Once the PC is removed from the mixture, the resulting slurry is ready for further separation by, for example, subjecting the slurry to a gravity-based centrifuge process. During centrifugation, the components of the slurry are preferably suspended in a solvent, as nonlimiting examples, water, PC, or acetone. While relatively low-density carbon-based materials (e.g., carbon black) remain suspended in the solvent, higher density electrode active materials tend to separate from the slurry during centrifugation. Once separated, the electrode active materials may be subjected to additional processes of types known to in the art to obtain higher-purity electrode active materials. The recovered electrode active materials may be vacuum-dried, for example, at temperatures of about 40° C. to about 200° C.

From the investigations, it was concluded that a method as described above is capable of recovering electrode active materials, such as transition metal oxides for cathodes and graphite and silicon for anodes, which can be further regenerated for reuse in new Li-ion battery manufacturing. Advantageously, such a method is able to use PC (propylene carbonate) as a more environmentally friendly solvent to recover electrode active materials in a relatively short time and at relatively low temperatures (e.g., 100° C. and less). Furthermore, the investigations evidenced that the recovered electrode active materials did not lose their functional material properties and electrochemical reactivities during the liberation/separation process, but instead retained their original particle morphology, crystal structure, and electrochemical performance, indicating that the PC-based process preserved essential characteristics of the cathode material and was therefore well suited for use in direct cathode recycling.

Moreover, the recovered cathode materials exhibited improved charge transfer resistance despite the presence of impurities on the surfaces of the active material. This improvement was attributed to the transformation of PVDF residues into a Li-ion conducting polymer layer during the PC-based process. This aspect addresses the challenges of completely removing PVDF/C residues from particles of electrode active materials and demonstrated the effectiveness of the PC-based process in dealing with this issue.

As previously noted above, though the foregoing detailed description describes certain aspects of one or more particular embodiments of the invention and investigations associated with the invention, alternatives could be adopted by one skilled in the art. For example, process parameters such as temperatures and durations could be modified, and appropriate materials could be substituted for those noted. As such, and again as was previously noted, it should be understood that the invention is not necessarily limited to any particular embodiment described herein or illustrated in the drawings.

1. A method of recovering at least one electrode active material from a lithium-ion battery or a component thereof, the method comprising:
providing an electrode sheet by separating the electrode sheet from a lithium-ion battery or obtaining the electrode sheet as a component of a lithium-ion battery, the electrode sheet comprising an electrode active material, a polyvinylidene fluoride binder, and a current collector;
immersing at least a portion of the electrode sheet in propylene carbonate;
while at least the portion of the electrode sheet is immersed in the propylene carbonate, delaminating the electrode active material from the current collector and forming a solid/liquid mixture comprising the electrode active material suspended in the propylene carbonate and the polyvinylidene fluoride binder dissolved in the propylene carbonate; and
separating the propylene carbonate from the solid/liquid mixture and separating the electrode active material from the polyvinylidene fluoride binder and the current collector.

2. The method of claim 1, wherein the electrode active material is delaminated from the current collector at a temperature of above 60° C.

3. The method of claim 1, wherein the electrode active material is delaminated from the current collector at a temperature of above 60° C. up to 100° C.

4. The method of claim 1, wherein at least the portion of the electrode sheet is immersed in propylene carbonate at a weight ratio of the portion to the propylene carbonate of about 1:1 to about 1:15.

5. The method of claim 1, wherein the electrode sheet is an anode sheet or a cathode sheet of a lithium-ion battery.

6. The method of claim 1, wherein the electrode sheet is separated from the lithium-ion battery and the separating step comprises removing the electrode sheet from the lithium-ion battery.

7. The method of claim 1, wherein the electrode sheet is obtained as the component of a lithium-ion battery, and the component is an electrode scrap.

8. The method of claim 1, wherein the electrode active material has a lithium-nickel-manganese-cobalt composition.

9. The method of claim 1, wherein the electrode active material obtained by the separating step comprises particles with surfaces having a residue comprising molecules of the propylene carbonate in polymer chains of the polyvinylidene fluoride binder.

10. The method of claim 9, wherein the residue is a Li-ion conducting polymer layer.

11. The method of claim 1, further comprising producing an electrode with the electrode active material obtained by the separating step, wherein the electrode produced with the electrode active material obtained by the separating step exhibits a lower charge-transfer resistance than the electrode sheet.
